(19) United States
(12) Patent Application Publication
(10) Pub. No.: US 2016/0048492 A1
(43) Pub. Date: Feb. 18, 2016

(54) Platform for internet based graphical communication

(71) Applicant: Emoji 3.0 LLC, Incline Village, NV (US)

(72) Inventors: Alex Barrett, Truckee, CA (US); Sergei Gorshunov, Dubai (AE)

(73) Assignee: Emoji 3.0 LLC, Incline Village, NV (US)

(21) Appl. No.: 14/752,910

(22) Filed: Jun. 27, 2015

Related U.S. Application Data
(60) Provisional application No. 62/018,647, filed on Jun. 29, 2014.

(51) Int. Cl. G06F 17/24; G06F 17/30; G06F 17/22

(52) U.S. Cl. CPC G06F 17/241; G06F 17/243; G06F 17/2247; G06F 17/30864

(57) ABSTRACT

Currently opinion on the internet is expressed in either lengthy text based content or non-specific and non-unified rating systems such as star ratings and other non-descript and vague rating systems. The present invention called the “Emoji 3.0 Platform” is a system for users to quickly, graphically share opinion and ideas regarding any product, service, person or place, thing or concept throughout the internet. The Emoji 3.0 Platform offers users a graphical and structured way to express their opinion and to also see the graphically represented opinions of others at a glance. Users can quickly identify specific key elements of the page content, by viewing aggregated graphical community opinion and ideas that have been previously tagged to the subject matter of the page. Additionally, users can search the internet for specific subject matter that has been graphically tagged with other users opinions, ideas, or views.

### CROSS-REFERENCE TO RELATED APPLICATIONS

This application claims the benefit of U.S. Provisional Application No. 62/018,647 filed Jun. 29, 2014, the disclosure of which is incorporated herein by reference.

### BACKGROUND

Currently opinion on the internet is expressed in either lengthy text based content or non-specific and non-unified rating systems such as star ratings and other non-descript and vague rating systems. This leaves users the option of either spending a long time reading and writing reviews, or alternatively, watering down specific concepts and opinions of good and bad features or ideas into meaningless, consolidated units of measurement like (overall star ratings) that fail to express unique opinion of the various facets of the subject matter.

In addition to the lack of a system for concise communication per the description above, there is also no way for web users to provide tagged opinion and commentary either via glyph or text on an internet page, outside the constraints of the page's unique format and allowances. Many internet pages don't offer a user commentary section and if they do, the resulting content is unstructured, non-unified data that does little to help in providing a clear signal regarding opinion and perspective. The web user's voice is lost in the ever growing cumulation of text overload and non-specific ratings, rather than contributing to a structured, clear and aggregated signal.

Because these concepts and opinions are often buried within unstructured data in the form of written reviews, search results are also often inspecific or unrelated to the subject matter the user truly seeks. Additionally, user reviews, opinions and ideas regarding the same subject matter can be scattered across many different internet pages and sites which do not contribute to an aggregated unified voice.

### BRIEF SUMMARY OF THE INVENTION

The present invention henceforth called the “Emoji 3.0 Platform” is a system for users to quickly, graphically share opinion and ideas regarding any product, service, person or place, thing or concept throughout the internet. The Emoji 3.0 Platform is comprised of the Emoji 3.0 Toolbar, Emoji 3.0 Mobile Application, and Emoji 3.0 Website, which utilize Emoji 3.0 icons.

### Emoji 3.0 Icons

An Emoji 3.0 icon is a graphically represented opinion or perspective of any product, service, person or place, thing or concept that can be tagged to internet based content. Emoji 3.0 icons can be glyphs of various embodiments and will convey ideas and opinions pertaining to specific qualities of things. For example, Emoji 3.0 icons could represent ideas such as (but not limited to) “great coffee”, “fast shipping”, “poor battery life”, “great views”, “family friendly dining”, “bad customer service”, “great design”, “expensive”, “great value”, and so forth. Emoji 3.0 icons allow users to get a sense for specific community opinion of a subject matter of interest with a quick glance.

### Emoji 3.0 Toolbar

The Emoji 3.0 Toolbar is an internet based communication platform that allows users to contribute their opinion or views about the content of an internet page in the form of a graphical icon or “Emoji 3.0 icon”. Users will be able to post their specific views graphically by “tagging” internet pages with Emoji 3.0 icons. Users can also review other's opinions or views graphically, and even search for web content that has been previously “tagged” with Emoji 3.0 icons.

In addition to being a quick way for users to graphically share thoughts, the Emoji 3.0 Toolbar will also offer the ability to share your thoughts with other users even when the internet page being tagged has no native social forum or content fields. In a sense, the emoji toolbar is a graphical communication “shell” for all internet based content.

Because Emoji 3.0 icons used within the toolbar represent opinions, ideas and views pertaining to the specific content of an internet page, the result of the collected data will provide a meaningful, and clearer signal of internet user community opinion.

### Emoji 3.0 Mobile Application

The Emoji 3.0 Mobile Application is a mobile solution for tagging Emoji 3.0 icons to either a place (ie: a restaurant, store, any other kind of business, or location), products, or internet based content using a smartphone or mobile device.

In addition to tagging, users will be able to search for products, restaurants, other types of businesses, as well as other content by entering a combination of words and Emoji 3.0 icons. The mobile application will provide results of relevant content based on the prevalence of matching Emoji 3.0 icons that have been previously tagged to relevant content using either the Emoji 3.0 Toolbar or Mobile Application.

### Emoji 3.0 Website

The Emoji 3.0 Website will offer search functionality using Emoji 3.0 icons. Users of the Emoji 3.0 website will have the ability to find content on the internet by searching for content that has been previously tagged with Emoji 3.0 icons. Additionally, users of the Emoji 3.0 Website will have access to analytics based on structured data that has been generated by internet user community use of the Emoji 3.0 Platform.

### BRIEF DESCRIPTION OF DRAWINGS:

FIG. 1A shows a basic schematic representation of the Emoji 3.0 Toolbar functionality where the user is preparing to tag a page with Emoji 3.0 icons.

FIG. 1B shows a basic schematic representation of the Emoji 3.0 Toolbar functionality where the user is selecting relevant Emoji 3.0 icons to tag an internet page.

FIG. 1C shows a basic schematic representation of the Emoji 3.0 Toolbar functionality where the user is viewing the recently tagged Emoji 3.0 icons including the one the user tagged in FIG. 1B.

FIG. 2 shows a basic schematic representation of the Emoji 3.0 Toolbar functionality where the user can toggle views between popular “aggregated” Emoji 3.0 icons and recent Emoji 3.0 icons.

FIG. 3A shows a basic schematic representation of the Emoji 3.0 Toolbar functionality where the user is preparing to search for internet content using Emoji 3.0 icons.

FIG. 3B shows a basic schematic representation of the Emoji 3.0 Toolbar functionality where Emoji 3.0 icons are offered to the user for a search based on the text input in the search field.

FIG. 3C shows a basic schematic representation of the Emoji 3.0 Toolbar functionality where the user is selecting Emoji 3.0 icons to establish the search criteria.

FIG. 3D shows a basic schematic representation of the Emoji 3.0 Toolbar functionality where the user has established the search criteria based on Emoji 3.0 icons and is executing a search.

FIG. 3E shows a basic schematic representation of the Emoji 3.0 Toolbar functionality where the user can view search results based on the search criteria of Emoji 3.0 icons established in FIG. 3D.

FIG. 4A shows a basic schematic representation of the Emoji 3.0 Mobile Application functionality where the user is preparing to tag a location (coffee house) with relevant Emoji 3.0 icons.

FIG. 4B shows a basic schematic representation of the Emoji 3.0 Mobile Application functionality where the user is selecting relevant Emoji 3.0 icons to tag a location (coffee house) with relevant Emoji 3.0 icons.

FIG. 4C shows a basic schematic representation of the Emoji 3.0 Mobile Application functionality where the user can view the recently tagged Emoji 3.0 icons including the one the user tagged in FIG. 4B.

FIGS. 5A, 5B and 5C show basic schematic representations of the Emoji 3.0 Mobile Application functionality where the user is viewing popular or relevant Emoji 3.0 icons about a location (coffee house) and the user can toggle the screen to see other relevant information (address seen in FIG. 5B and map seen in FIG. 5C) about the location.

FIGS. 6A and 6B show basic schematic representations of the Emoji 3.0 Mobile Application functionality where the user is able to scroll left or right to view other nearby locations that they may wish to tag with Emoji 3.0 icons or view popular or recent Emoji 3.0 icons.

FIG. 7A shows a basic schematic representation of the Emoji 3.0 Mobile Application functionality where the user is preparing to search using the OR code scan function.

FIG. 7B shows a basic schematic representation of the Emoji 3.0 Mobile Application functionality where the user is using the OR code scan to scan a product (cereal seen in FIG. 7C).

FIG. 7C shows a basic schematic representation of the Emoji 3.0 Mobile Application functionality where the user is able to view popular Emoji 3.0 icons that have been tagged about the product that was scanned by OR code in FIG. 7B.

FIG. 7D shows a basic schematic representation of the Emoji 3.0 Mobile Application functionality where the user choosing to tag a product with Emoji 3.0 icons that has been scanned and loaded using the OR code scanning function in FIG. 7B.

FIG. 7E shows a basic schematic representation of the Emoji 3.0 Mobile Application functionality where the user is selecting Emoji 3.0 icons to tag a product (cereal).

FIG. 8A shows a basic schematic representation of the Emoji 3.0 Mobile Application functionality where the user is preparing to search using Emoji 3.0 icons.

FIG. 8B shows a basic schematic representation of the Emoji 3.0 Mobile Application functionality where the user is entering text in the search field and being offered relevant Emoji 3.0 icons to establish search criteria.

FIG. 8C shows a basic schematic representation of the Emoji 3.0 Mobile Application functionality where the user is selecting Emoji 3.0 icons for search criteria.

FIG. 8D shows a basic schematic representation of the Emoji 3.0 Mobile Application functionality where the user is viewing search results based on Emoji 3.0 icons search criteria and selecting a result (location) to view.

FIG. 8E shows a basic schematic representation of the Emoji 3.0 Mobile Application functionality where the user is viewing popular Emoji 3.0 icon data about the selected location that was found using the Emoji 3.0 icon search criteria selected in FIG. 8C.

FIGS. 9A-9H show basic schematic representations of the Emoji 3.0 Website functionality where the user is entering text in the search field and being offered Emoji 3.0 icons related to the text input. The user then selects Emoji 3.0 icons to create the search criteria. Search results based on the Emoji 3.0 icon search criteria appear in the Emoji 3.0 website search results display area seen in FIG. 9D. The user is able to refine search results based on selecting new Emoji 3.0 icons to add to the search criteria from the Emoji 3.0 icons seen in the search results (FIG. 9E). The user can also remove Emoji 3.0 icons from the search criteria in order to view results in a broader search criteria as seen in FIGS. 9G and 9H.

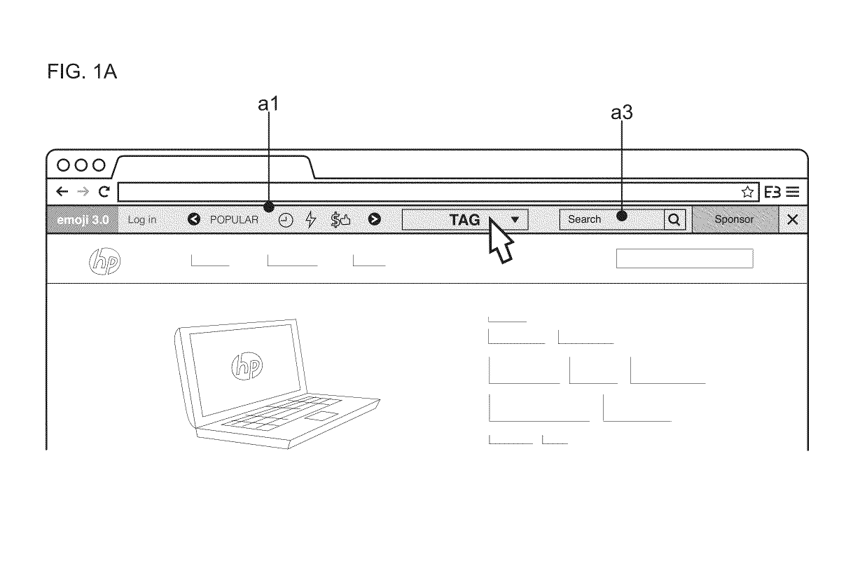

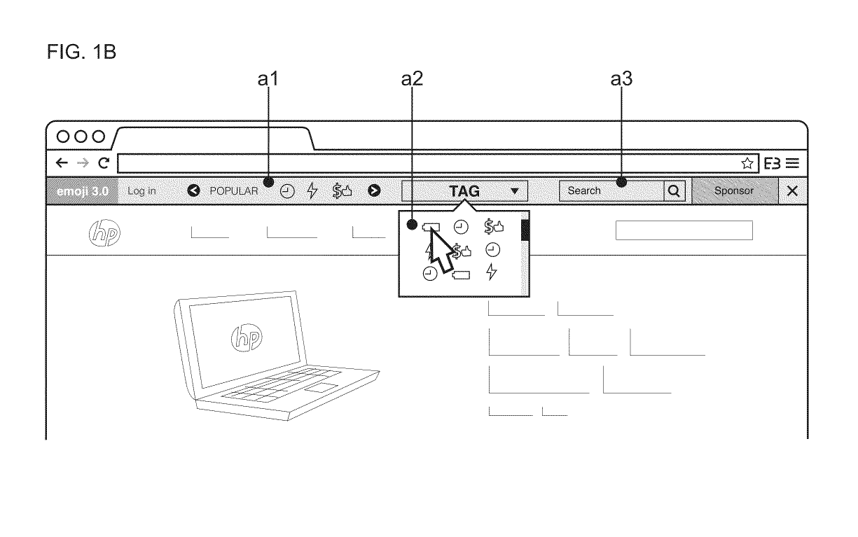

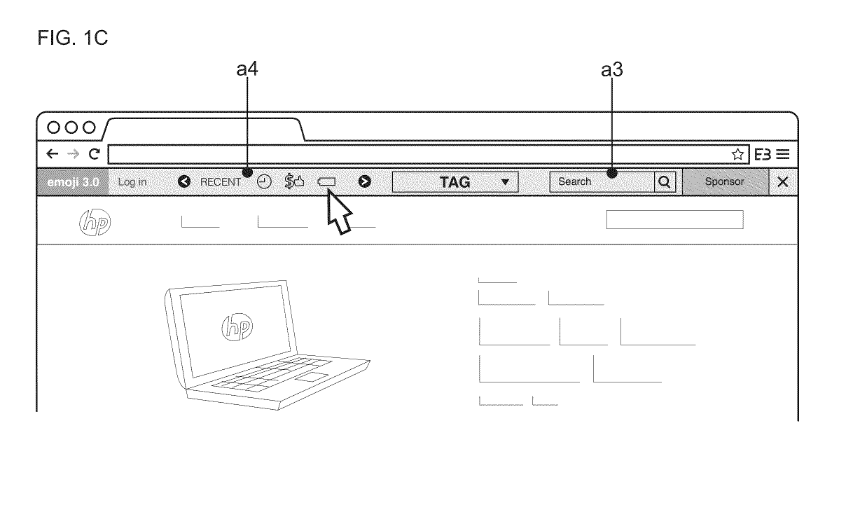

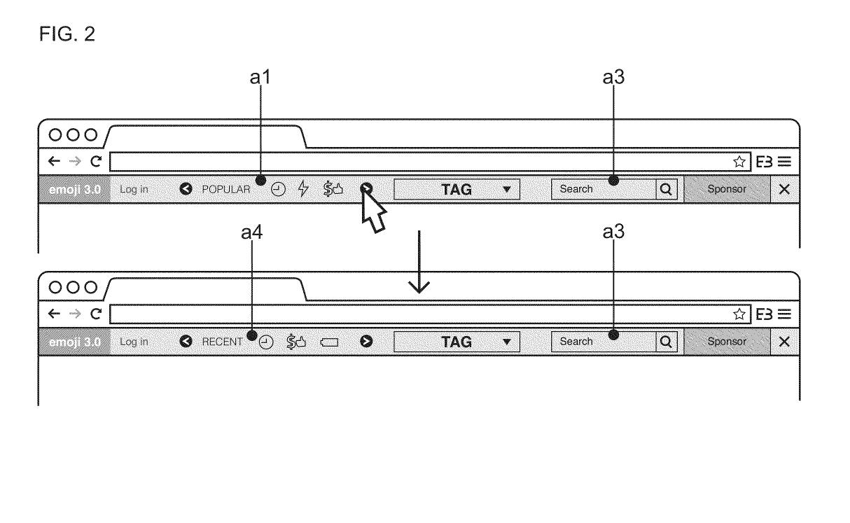

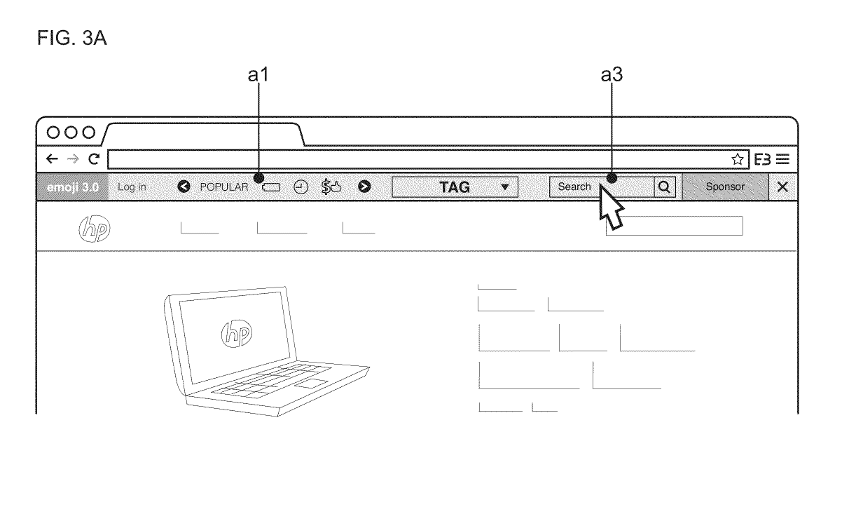

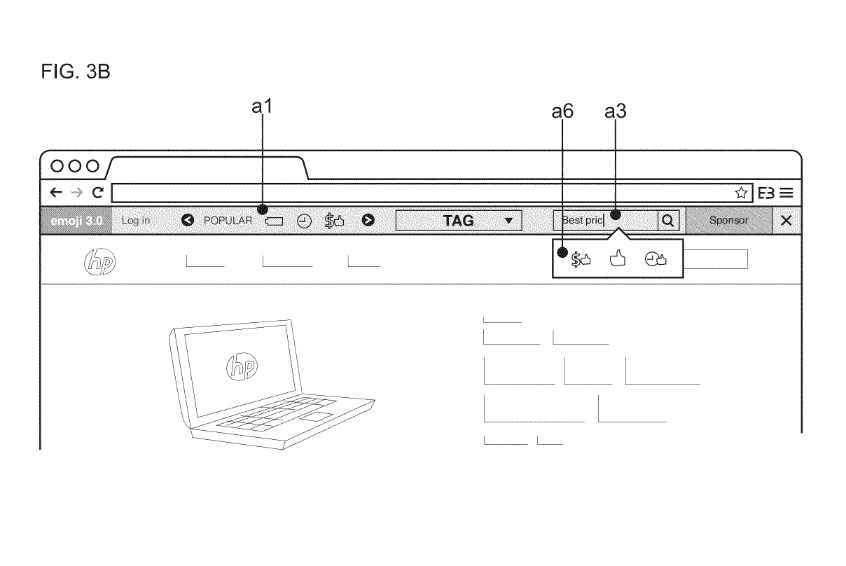

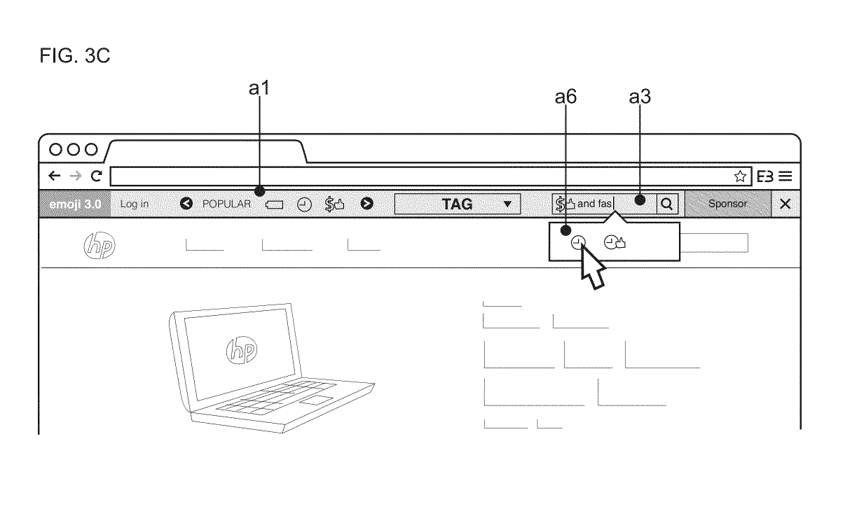

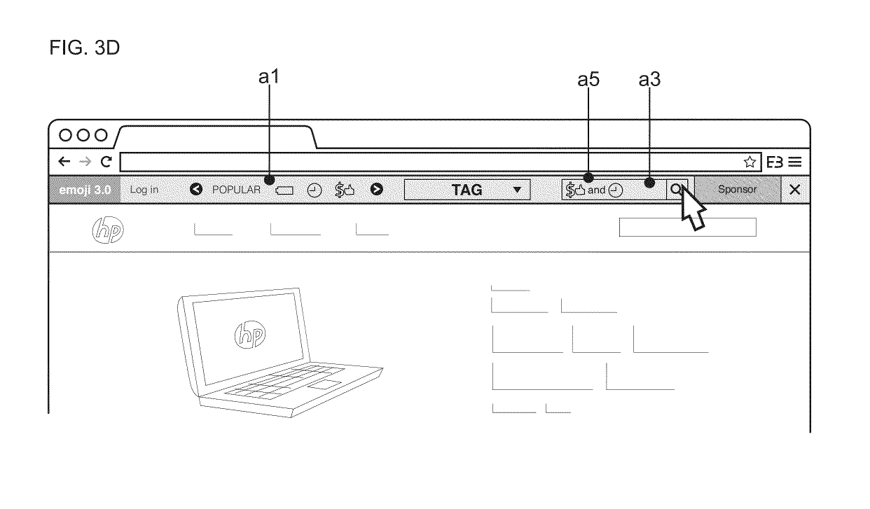

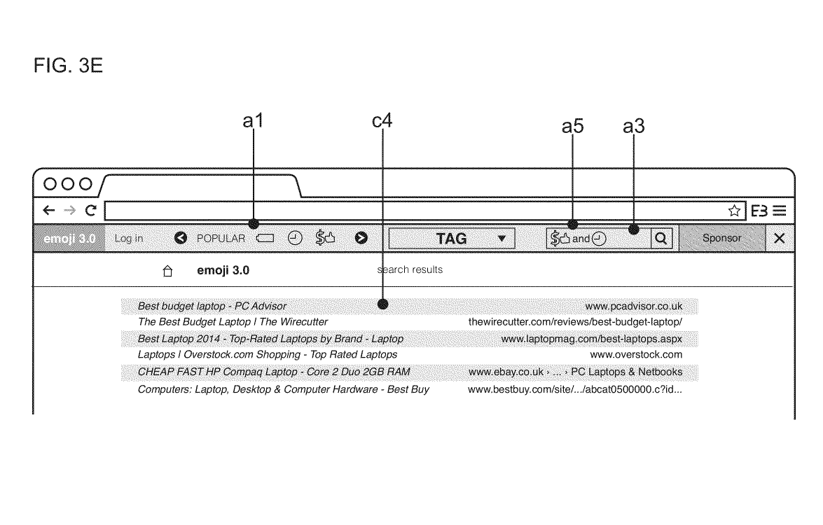

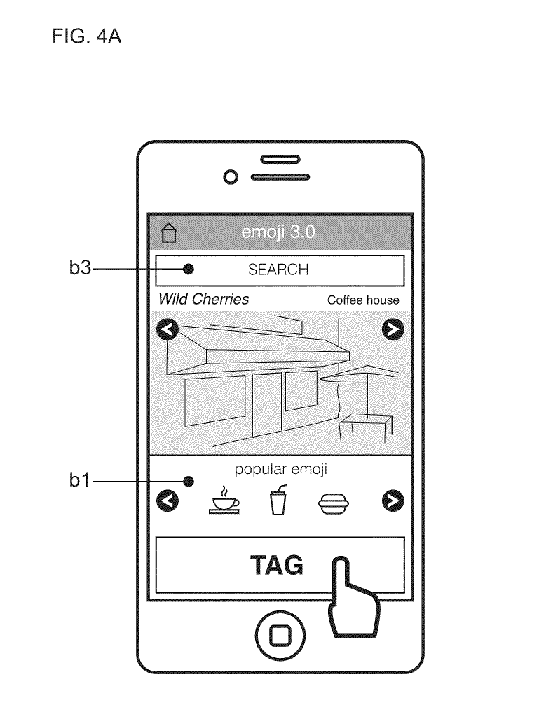

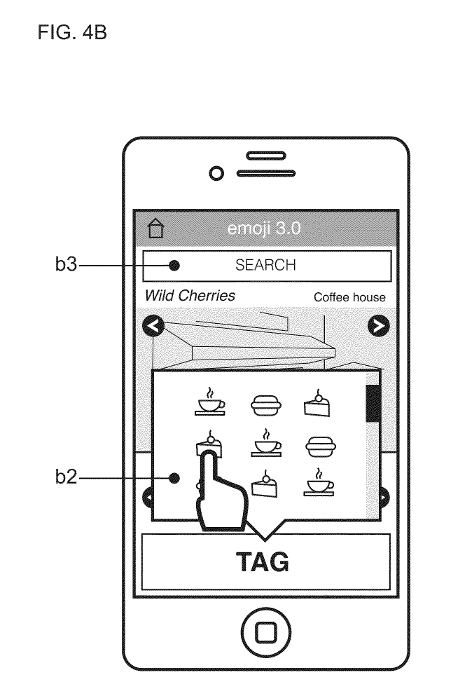

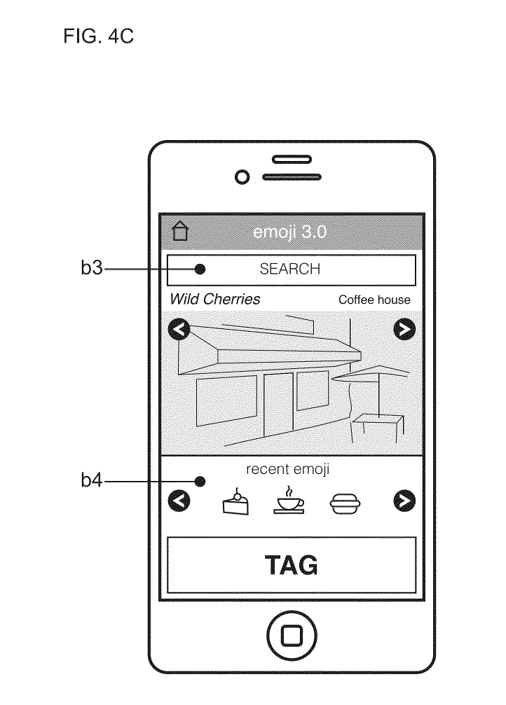

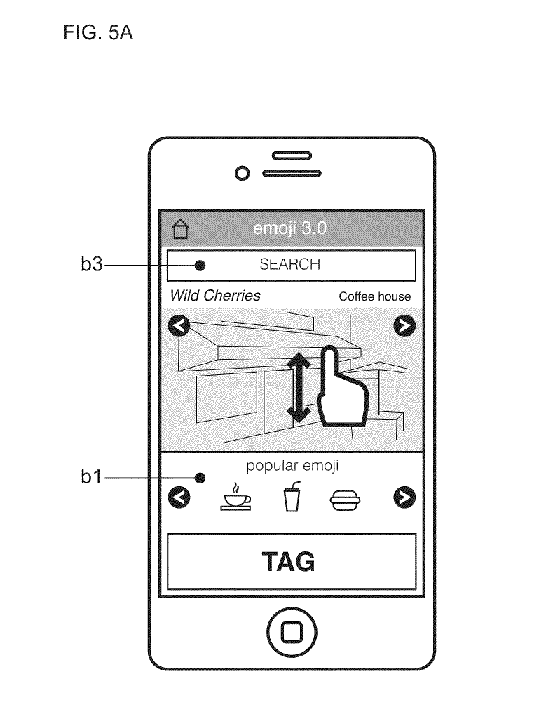

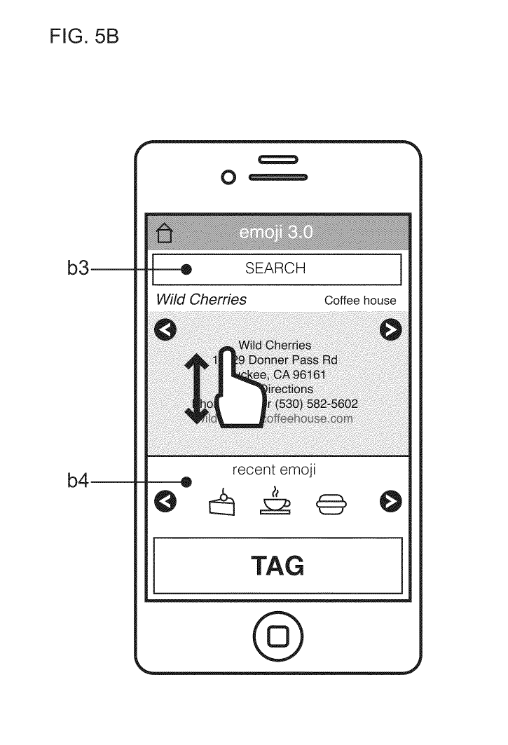

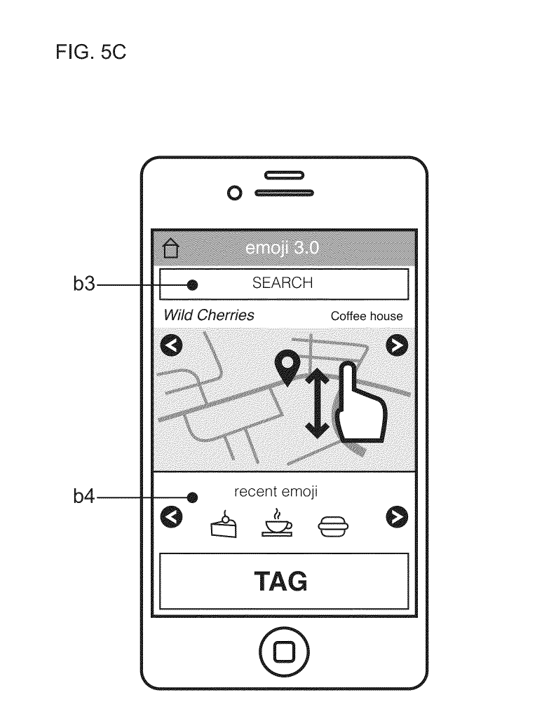

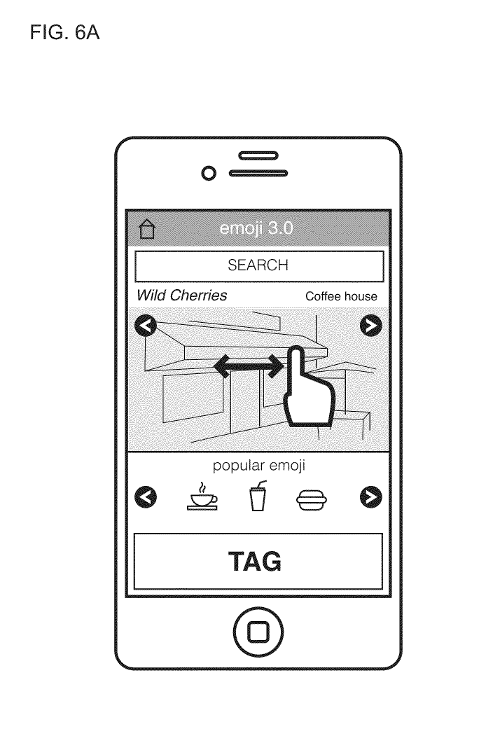

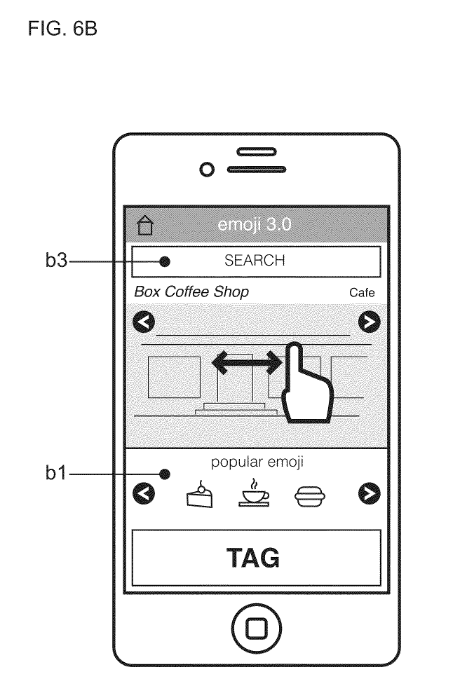

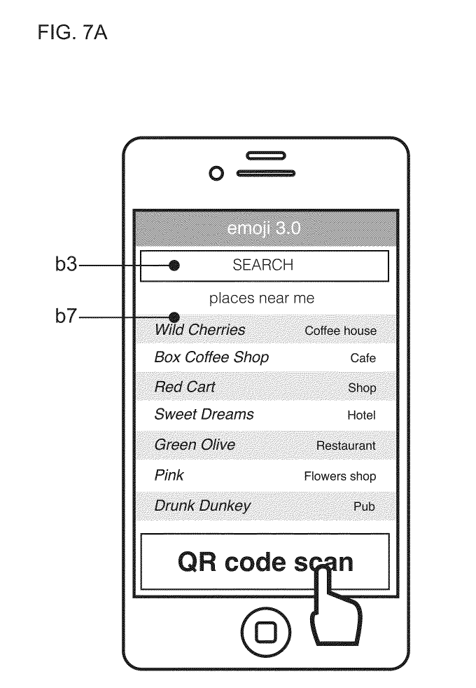

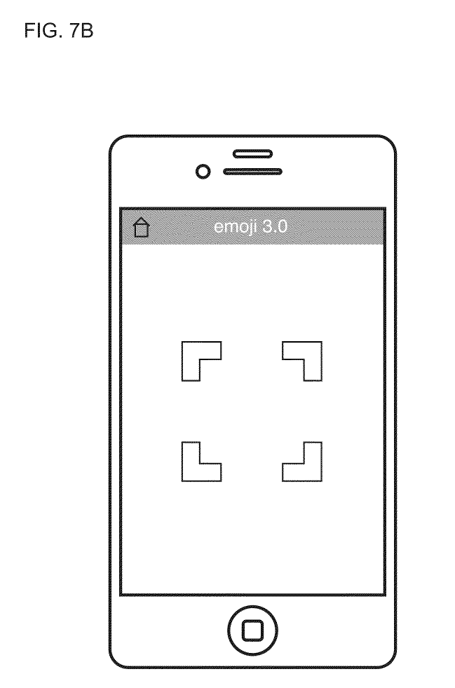

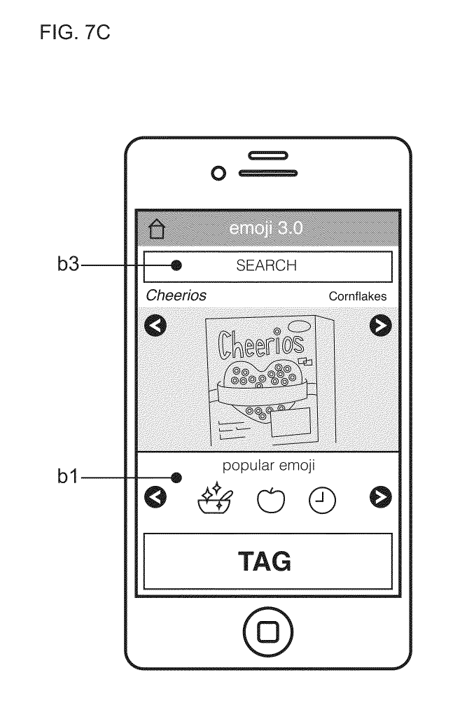

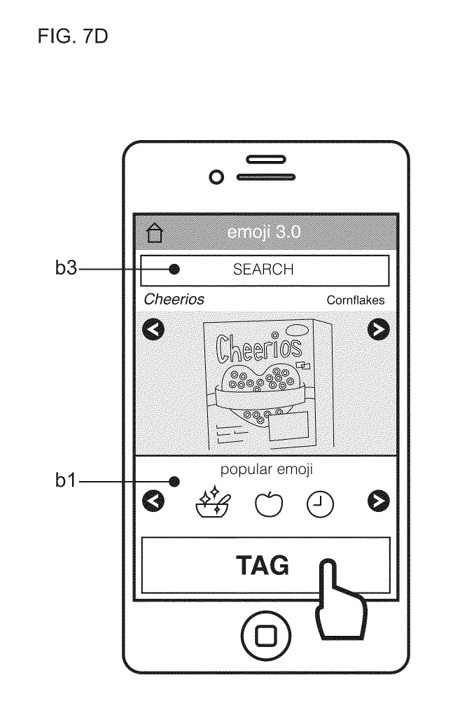

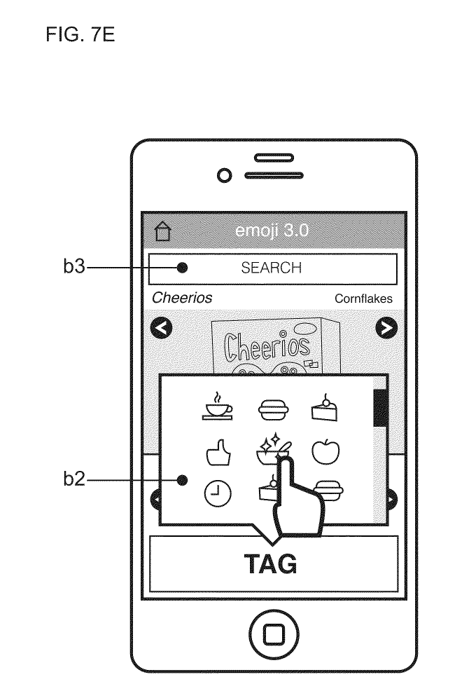

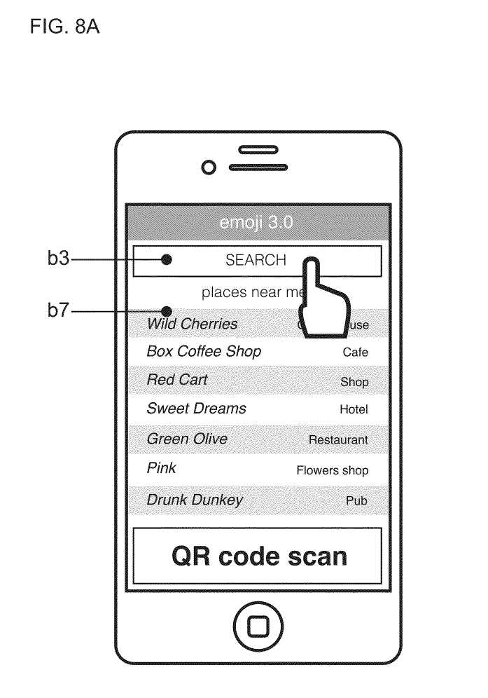

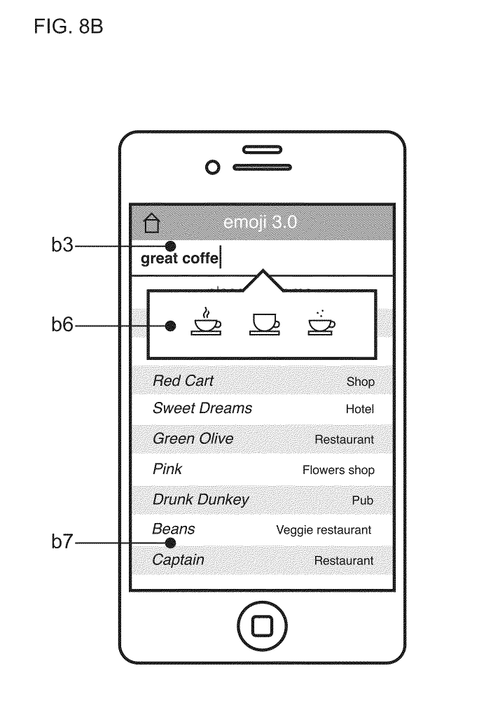

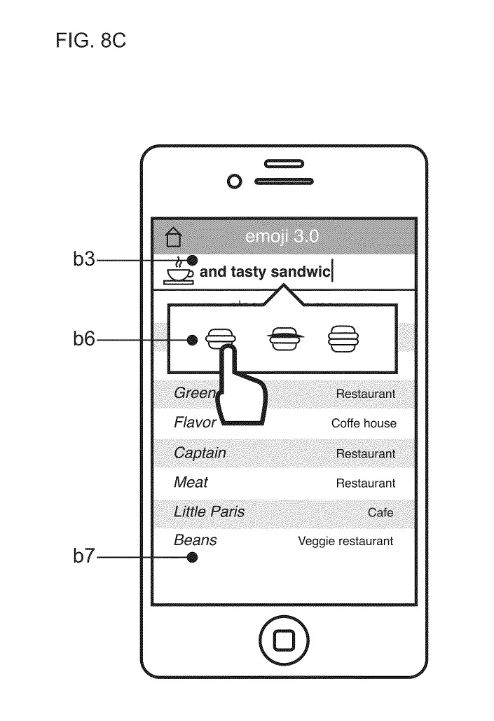

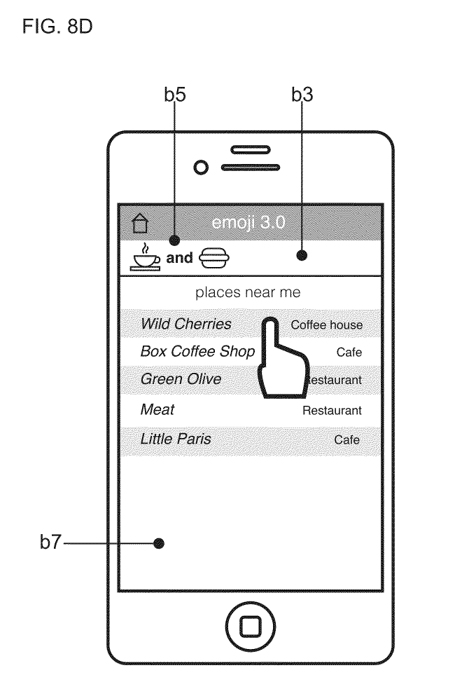

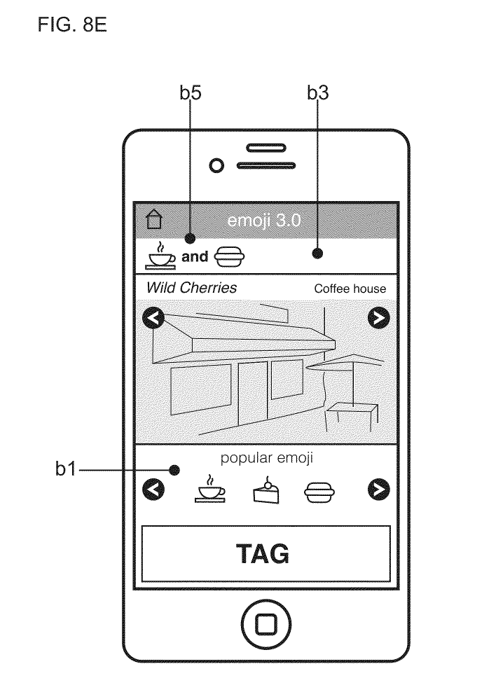

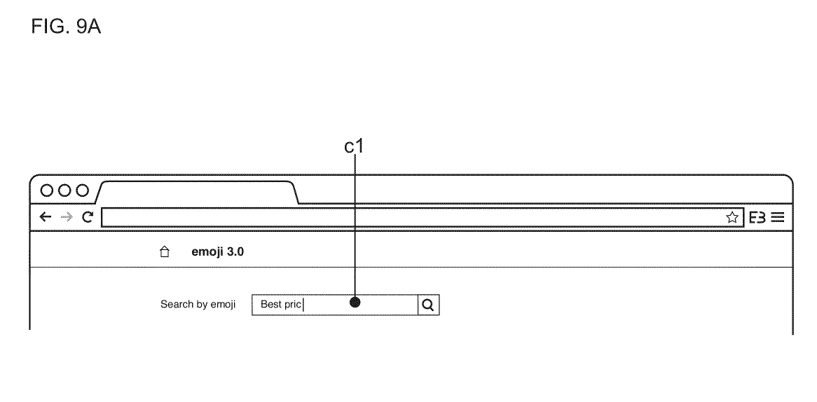

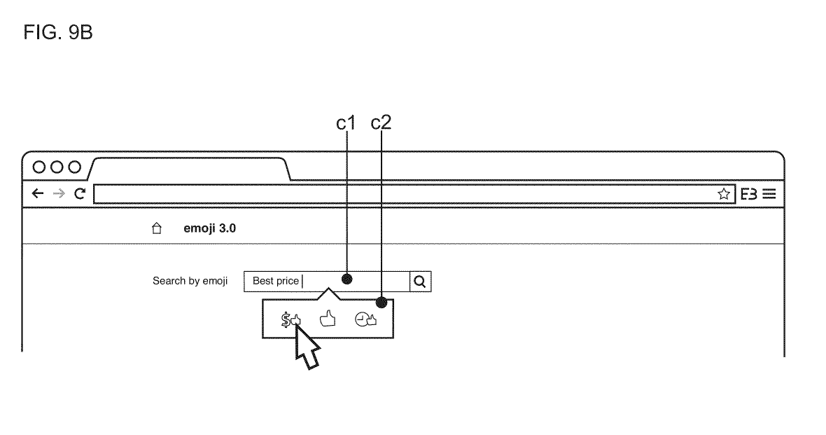

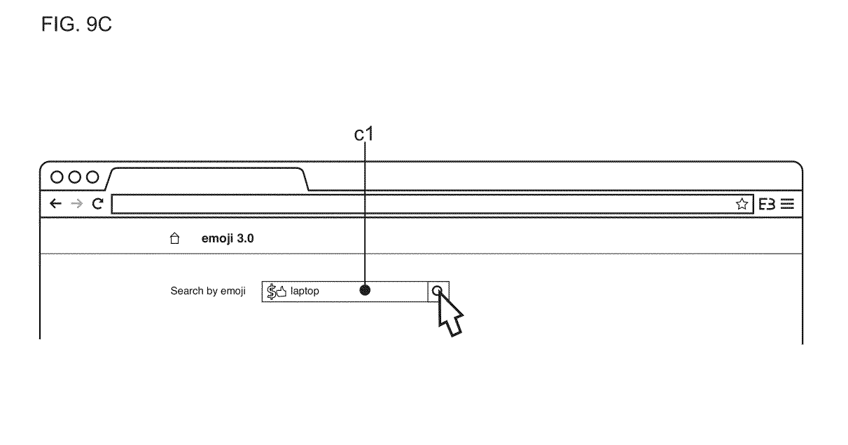

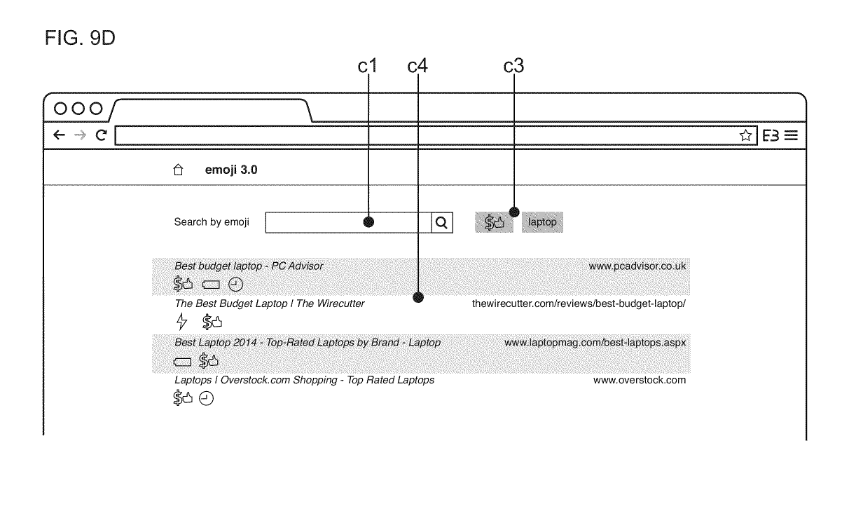

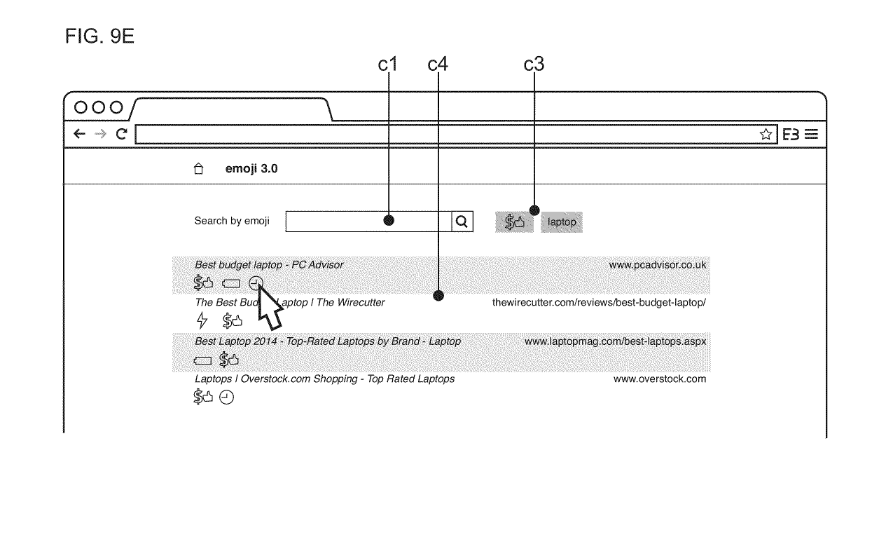

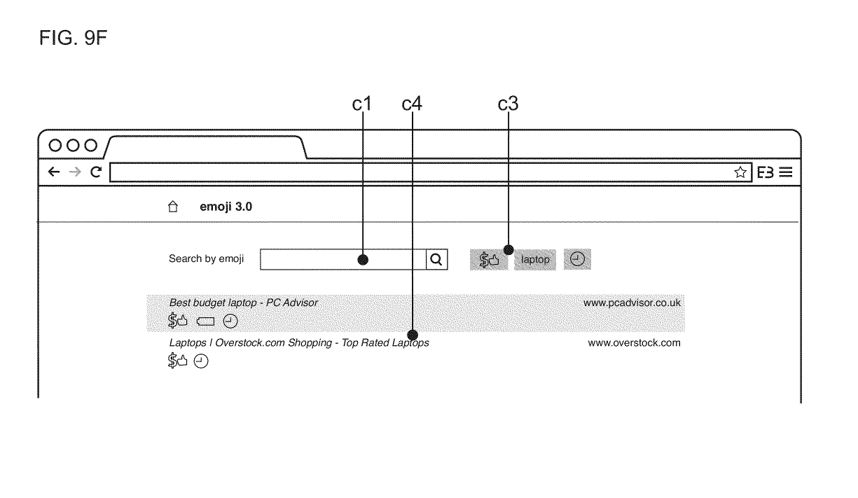

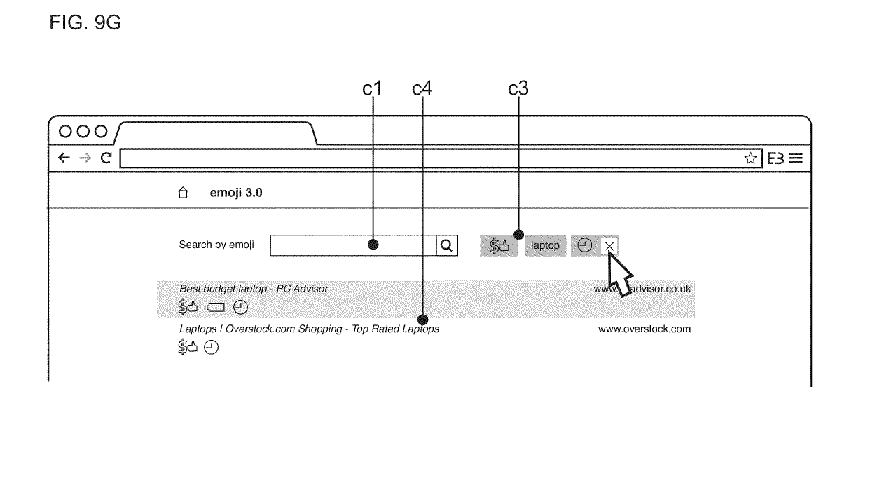

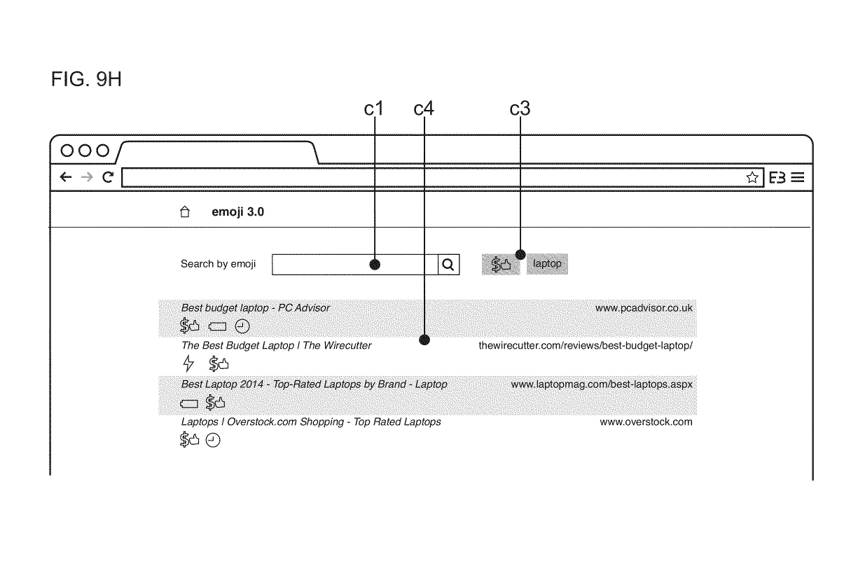

### DETAILED DESCRIPTION:

The Emoji 3.0 platform provides specific user opinion and ideas graphically using Emoji 3.0 icons, allowing users to get a clear understanding of user generated opinion, ideas and concepts relating to the content, at a glance. Users of the Emoji 3.0 Platform can also share their opinion quickly by tagging internet pages, places, businesses, and products, graphically with Emoji 3.0 icons that express their thoughts, rather than writing lengthy content. Additionally, the Emoji 3.0 platform will act to unify user opinion regarding the same subject matter that is spread across multiple, otherwise unrelated internet pages. Searching for content on the internet is also made easier because the data collected during the tagging process is structured.

Emoji 3.0 icons are different from the regular use Emoji that we know today because they communicate specific concepts, views and ideas rather than just basic emotions and more literal icon=object or word based translations. Emoji 3.0 icons provide a quicker and more specific way to communicate and share opinions or concepts on the web. The Emoji 3.0 Platform also provides a venue for graphically sharing views or concepts on web based content for pages where commentary input options don't already exist. The Emoji 3.0 Platform allows users to be able to search for content on the web based on user generated Emoji 3.0 icon data and not the actual content that exists on the page. This creates a whole new way to search and navigate internet content in a more specific and different way. It is a universal graphical commentary shell or wrap for the internet and any internet based content where users can graphically share ideas and opinion about the content of a page, outside of the actual page (within the toolbar). This allows for graphical user commentary to attach to the internet page or subject matter without the permission of the page owner.

Other internet based commentary systems are either lengthy written opinions and concepts mixed and scattered throughout social forums that take a long time to read and are very difficult to structure into a defined and specific signal or voice. More consolidated opinion on subject matter such as star ratings are too vague to reflect the specific qualities of most subjects without combining them with more detailed, written content that is not universally structured data.

It can be difficult for users to quickly identify key elements of the content when other users opinion or ideas are scattered throughout the page content in the form of unstructured written content or vague star or numerical rating systems that fail to provide specifics. The unstructured data is also not aggregated or searchable in the same ways as structured data.

The Emoji 3.0 Platform offers users a graphical and structured way to quickly express their opinion and to also see the graphically represented opinions of others at a glance. Users can quickly identify specific key elements of the page content, by viewing aggregated graphical community opinion and ideas that have been previously tagged to the subject matter of the page. Users can also search more accurately, using Emoji 3.0 icons to search for pages or content that have been specifically tagged with the same Emoji 3.0 icons.

### Components and Elements:

The Emoji 3.0 Platform consists of or makes use of the listed components and elements below:

### Components:

(a) Emoji 3.0 toolbar
(b) Emoji 3.0 Mobile application
(c) Emoji 3.0 website
(d) Emoji 3.0 icons
(e) Server
(f) Database

### Elements:

(a1)) Toolbar Aggregated emoji display area
(a2) Toolbar Emoji 3.0 selection area
(a3) Toolbar Search field
(a4) Toolbar Recent emoji 3.0 icon display area
(a5) Toolbar Search criteria
(a6) Toolbar Search emoji selection area
(b1) Mobile aggregated Emoji 3.0 icons display area
(b2) Mobile Emoji 3.0 selection area.
(b3) Mobile search field
(b4) Mobile recent Emoji 3.0 icons display area
(b5) Mobile search criteria
(b6) Mobile search emoji selection area
(b7) Mobile search results display area
(c1) Emoji 3.0 website search field
(c2) Emoji 3.0 website Emoji 3.0 selection area
(c3) Emoji 3.0 website search criteria
(c4) Emoji 3.0 website search results display area

### Relationship Between the Components in the Current Embodiment:

Emoji 3.0 icons (d) are contained in the Toolbar aggregated emoji area (a1), Toolbar emoji 3.0 selection area (a2), Emoji 3.0 Toolbar recent icons display area (a4), Toolbar Search criteria (5), Toolbar Search emoji selection area (a6), Mobile aggregated Emoji 3.0 icons display area (b1), Mobile Emoji 3.0 selection area (b2), Mobile recent Emoji 3.0 icons display area (b4), Mobile search criteria (b5), Mobile search emoji selection area (b6), Mobile search results display area (b7), Emoji 3.0 website Emoji 3.0 selection area (c2), Emoji 3.0 website search criteria (c3), and Emoji 3.0 website search results display area (c4)
(a1) . . . (a6) are contained in (a)
(b1) . . . (b7) are contained in (b)
(c1) . . . (c4) are contained in (c)

The Emoji 3.0 Toolbar (a), Emoji 3.0 Mobile application (b) and Emoji 3.0 Website (c) act as a “front end” where the user can input Emoji 3.0 icons (d) and text (optionally), and see the output in the form search results based on content previously tagged with Emoji 3.0 icons (d).

Elements: (a2), (a3) , (a5), (a6), (b2), (b3), (b5, (b6), (c1), (c2) (c3) are used for the input of Emoji 3.0 icons and text to be transmitted to the server (e) and stored in the database (f).

Elements: (a1), (a4),(b1),(b4), b7), (c4) are used for output of aggregated or most recent Emoji 3.0 icon (d) data or search results from the database (f) on the server (e).

The server (e) and database (f) are used to store input data, calculate, aggregate and return output data in the form of Emoji 3.0 icons (d), and search results which are based on Emoji 3.0 icon (d) data.

### How the Emoji 3.0 Platform Works:

A user of the Emoji 3.0 Platform will share ideas and opinions graphically by tagging internet pages with emoji 3.0 icons (d) with a software user interface such as the toolbar (a), or mobile application (b). The software interface will transfer user input data to a database (f) on a server (e). The database (f) will contain structured data related to content on internet pages and other relevant subject matter. The structured data contained within the database (f) will be accessible to user queries from the toolbar(a), mobile app (b), or website (c). Additionally, when users are viewing content while using the toolbar (a) or mobile app (b), relevant aggregated or recent emoji 3.0 icons (d) that have been tagged previously to the subject matter will be displayed. This graphical Emoji 3 icon (d) data will give users an aggregated or recent summary view of community opinion or ideas relative to the internet page the user is currently viewing. Users of the Emoji 3.0 Platform can search for subject matter of interest by querying the database for content that has been previously tagged with emoji 3.0 icons. Any content or subject matter that has been previously tagged with emoji 3.0 icons that match the emoji 3.0 icons in the user interface search field will be returned as search results.

### Emoji 3.0 Toolbar (a) Functionality:

Any user with the toolbar (a) installed when browsing the internet will have added functionality for seeing aggregated graphically represented community opinion (Emoji 3.0 icons (d)) of the currently viewed subject matter of an internet page. Users will also have the ability to tag the subject matter of the internet page graphically with their own opinions or ideas using Emoji 3.0 icons (d) and the ability to search for things based on aggregated community opinion using a Emoji 3.0 icons (d) or a combination of Emoji 3.0 icons (d) and words.

The user selects an Emoji 3.0 icon (d) in the toolbar Emoji 3.0 selection area (b2) tagging the currently viewed subject matter of the internet page graphically. The data is transmitted to and from the database (f) on the server (e) and the emoji 3.0 icon (d) appears in the toolbar recent emoji 3.0 icon display area (a4) allowing users to see the most recent graphical community opinion or ideas on the subject matter. The Server (e) counts the most frequently picked emoji 3.0 icons (d) in the database (f) for the particular subject matter. These most frequently picked Emoji 3.0 icons (d) will then appear in the toolbar aggregated icons display area (a1)) allowing users to see aggregated graphical community opinion or ideas on the subject matter.

The User can also type Emoji 3.0 icon (d) descriptions in the toolbar search bar field (a3) or select Emoji 3.0 icons (d) in the toolbar search emoji 3.0 selection area (a6). When the Emoji 3.0 icons (d) are selected, they appear in the toolbar search field (a3) and the user may continue to type or select more emoji 3.0 icons (d). When all necessary emoji 3.0 icons (d) are in the toolbar search field (a3), the toolbar search criteria (a5) has been established and the user presses the search button and search results appear in the Emoji 3.0 website search results display area (c4). Search results are based on the toolbar search criteria (a5) and return results of subject matter or internet pages that have been previously tagged with Emoji 3.0 icons (d) that most closely match the toolbar search criteria (a5).

### Emoji 3.0 Mobile Application (b) Functionality:

Users with the Emoji 3.0 mobile application installed on a smartphone will have much of the functionality that the toolbar (a) provides but will also get new functionality specific to use with a smartphone or device. This added functionality specific to the mobile application (b) includes location based Emoji 3.0 Icon (d) tagging and search as well as tagging products that can be scanned using qr codes or similar product identification technology commonly available for smartphones.

For location based tagging, the Emoji 3.0 mobile application identifies a user's current location, and offers options of named locations relevant to the user's location, that can be rated (restaurant, shop, park, etc). Once the user selects the named location they wish to rate, the mobile app offers relevant Emoji 3.0 icons (d) in the Emoji 3.0 mobile selection area (b2). The user then tags Emoji 3.0 icons (d) to the subject matter selected that will be displayed in the mobile recent Emoji 3.0 display area (b4). The selected Emoji 3.0 icons (d) are also then transmitted to the database (f) on the server (e), which counts and aggregates the Emoji 3.0 icons (d). Other users can see the aggregated Emoji 3.0 icon (d) data displayed in either the mobile Emoji 3.0 aggregated icons display area (14) or in the Toolbar aggregated Emoji 3.0 icons display area (a1). Additionally, the data collected will be stored in the database (f) and contribute to future search results displayed in the search result display areas (b7)and (c7).

The User can also type Emoji 3.0 icon (d) descriptions in the mobile search field (b3) or pick up Emoji 3.0 icons (d) in the mobile search emoji 3.0 selection area (b6) . When Emoji 3.0 icons (d) are selected, they appear in the mobile search field (b3) and the user may continue to type or select more emoji 3.0 icons(d). When all necessary Emoji 3.0 icons (d) are in the mobile search field (b3), the mobile search criteria (b5) has been established and the user presses the search button and search results appear in the mobile search results display area (b7). Search results are based on the mobile search criteria (b5) and return results of subject matter or internet pages that have been previously tagged with Emoji 3.0 icons (d) that most closely match the search criteria (b5). Search results may also be displayed on the map providing the closest locations that have been tagged with relevant Emoji 3.0 icons (d).

A third way to find content using the Emoji 3.0 Mobile application (b) is with the QR code scanning function. Using the QR code scanner, the user can scan QR codes of interest and view content and related Emoji 3.0 icon (d) data. Users will also have the ability to tag the QR code related content with relevant Emoji 3.0 icons (d). The newly tagged Emoji 3.0 icon data will be compiled in the database (f) with all other Emoji 3.0 icon data relevant to the subject matter and will then become searchable using the Emoji 3.0 Toolbar (a) Mobile Application (b) or website (c).

### Emoji 3.0 Website (c) Functionality:

Users wishing to search using Emoji 3.0 icons (d) without having the toolbar installed can do so at the Emoji 3.0 website (c).

The User can type Emoji 3.0 icon (d) descriptions in the website search field (c1) or select Emoji 3.0 icons (d) in the website search emoji 3.0 selection area (c2) . When the Emoji 3.0 icons (d) are selected, they appear in the website search field (c1) and the user may continue to type or select more emoji 3.0 icons (d). When all necessary emoji 3.0 icons (d) are in the website search field (c1), the website search criteria (c3) has been established and the user presses the search button and search results appear in the Emoji 3.0 website search results display area (c4). Search results are based on the website search criteria (c3) and return results of subject matter or internet pages that have been previously tagged with Emoji 3.0 icons (d) (using the toolbar (a) or mobile application (b)) that most closely match the website search criteria (c3).

### How to Make the Currently Proposed Embodiment of the Emoji 3.0 Platform:

Elements (a1-a6) will be contained in the toolbar (a) and will be controlled by software that transmits data to and from the server (e) and is stored in the database (f). The software will translate data received by the Emoji 3.0 toolbar (a) from the database (f) on the server into graphically represented information (Emoji 3.0 icons (d)).

Elements (b1-b7) will be contained in the mobile application (b) and will be controlled by software that transmits data to and from the server (e) and is stored in the database (f). The software will translate data received by the Emoji 3.0 mobile application (b) from the database (f) on the server into graphically represented information (Emoji 3.0 icons (d)).

Elements (c1-c4) will be contained in the Emoji 3.0 website (c) and will be controlled by software that transmits data to and from the server (e) and is stored in the database (f). The software will display data (search results) received by the Emoji 3.0 website (c) from the database (f) in the Emoji 3.0 website search results display area (c4)

The server (e) will store the database (f) and transmit data between the database and components (a), (b), and (c).

### Necessary and Optional Components and Elements:

Necessary items include Emoji 3.0 icons(d), a server (e), database (f) and a method of tagging, searching for, and reviewing content tagged with Emoji 3.0 icons (d).

The first method of tagging, searching for, and reviewing content tagged with Emoji 3.0 icons (d) is the toolbar (a) which will contain or utilize elements (al-a6) and (c4).

A second method of tagging, searching for, and reviewing content tagged with Emoji 3.0 icons is the mobile application (b) which will contain or utilize elements (b1-b7).

A third method of searching for, and reviewing content tagged with Emoji 3.0 icons is the Emoji 3.0 website (c) which will contain or utilize elements (c1-c4).

### How Components Can Be Shuffled to Perform a Similar Function:

The Emoji 3.0 icons (d), server (e), and database (f) components are necessary for all aspects of the Emoji 3.0 Platform.

The Emoji 3.0 toolbar (a) is comprised of elements (al -a6) and will require the Emoji 3.0 website (c) in order to display search results in the Emoji 3.0 website search results display area (c4).

The Emoji 3.0 mobile application (b) is comprised of elements (b1-b7) and can work independently with the Emoji 3.0 icons (d), server (e), and database (f), but, when combined with data collected from the toolbar (a), there is an increased scope of user contribution and communication. The Emoji 3.0 mobile application (b) will also contribute to data stored in the database (f) which is output from the server (e) to the Emoji 3.0 toolbar (a) and the Emoji 3.0 website (c).

The Emoji 3.0 website (C) contains elements (c1-c4) and requires data that has been collected in the database (f) on the server (e) from the Emoji 3.0 toolbar (a), or Emoji 3.0 mobile application (b).

### Using the Emoji 3.0 Platform:

Instead of writing text, users place or “tag” internet content or location based subject matter with Emoji 3.0 icons (d) using the Emoji 3 toolbar (a) or mobile application (b), that describe what users feel or think regarding content of the webpage, a location, or product. For example: Instead of writing “good battery life”, the user would select and tag an internet page with an Emoji 3 icon that represents “good battery life”. The system then aggregates, counts and displays most popular emoji selected for that particular content.

Other users who visit a page (or a similar page that we have linked in or database) that has been previously tagged with Emoji 3.0 icons (d) will see the string of Emoji 3.0 icons (d) which represent most popular Emoji 3.0 icons (d) tagged for that content. Users can also choose to see the most recently tagged Emoji for the subject matter of the page.

Users can also search for things using the Emoji 3.0 platform by entering at least one Emoji 3.0 icon (d) of interest in the search field. Emoji 3.0 icons (d) can be combined with other Emoji or words to return a more specific set of search results. Any content previously tagged with Emoji that match the Emoji in the search field will appear in the search results. The pages or content that contain the most tags of relevant Emoji 3.0 icons (d) to the users search combined with subject matter relevant to any search words included will show up higher in the results. Users can then select the results that most closely match their search based on the user defined, structured Emoji data, and view the content.

### Other Uses of the Emoji 3.0 Platform:

Data collected from Emoji 3.0 icons (d) that have been tagged can provide analytical structured data for Market research in regard to user opinion, views and ideas using Emoji 3.0 icons (d).

Rewards systems and marketing promotions could be offered to users based on their participation in reviewing certain things with the Emoji 3.0 Platform.

Products and services could be offered to users based on the Emoji 3.0 icons (d) they often tag or the products or content they are searching for or tagging with Emoji 3.0 icons.

Companies will also have a new way of communicating to their users by gaining the ability to highlight qualities of their product using Emoji 3.0 icons (d).

Emoji 3.0 icon (d) data can also act to unify opinion and ideas regarding similar subject matter across multiple internet pages in different languages. This can help to bridge many language barriers for sharing opinion and ideas, while aggregating the collected data, creating a unified and clear, common voice.

1. A method for graphically representing user sentiment. The method comprising:
a) Graphically tagging a person, place or thing on a web or mobile page with a specific attribute represented by an icon
b) Viewing a graphic representation of user sentiment on a specific attribute
c) Searching for an attribute describing a person, place or thing based on popular community sentiment
Whereby user sentiment can easily be set, viewed and searched

2. A system for graphically representing user sentiment. The system comprising:
a) Graphically tagging a person, place or thing on a web or mobile page with a specific attribute represented by a graphical icon
b) Viewing a graphic representation of user sentiment on a specific attribute
c) Searching for an attribute describing a person, place or thing based on popular community sentiment
